(19) United States
(12) Patent Application Publication
(10) Pub. No.: US 2009/0317583 A1
(43) Pub. Date: Dec. 24, 2009

(54) Textile Sealing Membrane

(75) Inventor: Harry Naumann, Hoerstel-Riesenbeck (DE)

Correspondence Address: BOHAN MATHERS, PO BOX 17707, PORTLAND, ME, 04112-8707, US

(73) Assignee: BNP BRINKMANN NADELFILZ PRODUKTE GMBH & CO. KG, Hoerstel-Bevergern (DE)

(21) Appl. No.: 12/375,596

(22) PCT Filed: Jul. 27, 2007
(86) PCT No.: PCT/DE2007/001336

§ 371 Date: Aug. 14, 2009

(30) Foreign Application Priority Data
Aug. 1, 2006 (DE) 10 2006 035 767.1
Mar. 28, 2007 (DE) 20 2007 004 516.6
Jun. 21, 2007 (DE) 20 2007 008 688.1

(51) Int. Cl. D04H 1/04; D04H 1/08; B32B 3/06; B32B 27/02

(52) U.S. Cl. 428/86; 428/91; 442/320; 428/99; 442/326; 442/324

(57) ABSTRACT

The invention relates to a sealing membrane which is useful for closing out liquids and comprises moisture-absorbing, swellable fibres capable of generating a high swell pressure. The sealing membrane is constructed as a textile layer and may be disposed on the back of a moisture-impermeable layer of material of construction.

### BACKGROUND INFORMATION

1. Field of the Invention

The invention relates to a sealing membrane that serves to seal out liquids.

2. Description of the Prior Art

In the broadest sense, the term “liquids”, which is frequently mentioned hereinafter is generally understood to refer to water and liquids that contain water, which, when they come into contact with hydrophilic fibers, result in the fibers having a moisture-absorbing effect.

The term “textile layer” is understood to refer to a layer made of fibrous products and preferably constructed of fleece or felt, but which can also be made of woven fabric, knitted fabric, or non-crimp fabric.

The term “moisture-absorbing fibers” is understood hereinafter to refer to swelling fibers that enable a high absorption of water, thus resulting in intense swelling to thereby create a high swell pressure. Fibers used for this purpose have become well-known, for example, under the brand name “lyocell fibers”, in which the liquid is stored completely in the fibers, even at 100% humidity. The swell pressure can, for example, lie above 100 kg N.

In the prior art, such fibers have also been known as “moisture management polyester fibers”.

Previously, moisture-absorbing fibers were used either in clothing to wick away perspiration, in order to prevent a cooling effect when the moisture evaporates, or in hygienic textiles, to absorb moisture, for example, in children's diapers.

European patent specification EP 0 599 871 81 thus describes an absorbent article, particularly a sanitary napkin. The purpose of this intellectual property right is to provide disposable, absorbent articles with better fluid absorption and retention. Another task of this intellectual property right is to provide such articles with improved transportation of the fluid away from the skin, and a particular goal is to create hygienic pads and panty inserts with attributes such as increased softness and flexibility, while striving to achieve improved fit and improved stain reduction.

### BRIEF SUMMARY OF THE INVENTION

Fundamental to this proposal is that it is not essential that the moisture-absorbing fibers create a swell pressure, but, rather, they should only be provided in order to have a high storage character or capacity. The articles created according to this proposal should have high retention properties in order to better meet practical needs.

The task of this invention is, thus, to exploit moisture-absorbing fibers in an advantageous manner, such that these fibers achieve a sealing effect.

To fulfill this task, a textile sealing membrane is proposed that seals against liquids and is made exclusively or partially of moisture-absorbing fibers, whereby this textile layer is preferably constructed as a fleece and/or felt layer.

This arrangement provides a structure with which the sealing membrane that seals against liquids, for example, a pond liner, which, when damaged, becomes permeable to water at the damaged location. In other words, the hydrophilic fibers provided in this area are now subjected to high water absorption, whereby this high water absorption results in strong swelling of the fibers. A swell pressure builds up in the area of the damaged liquid-tight seal, when unrestricted swelling of the fibers is prevented, for example, by applying an appropriate load or by appropriate immobilization of the fibers, and this swell pressure results in the desired sealing effect for a limited volume with corresponding activity of the fibers.

This sealing membrane may be used, for example, in civil engineering applications, in above-ground and below-ground construction, in the field of building protection, tunnel construction, tunnel construction in underground mining, and in hydraulic engineering. This sealing membrane may also be used to seal flat roofs, or also in shipbuilding or for temporary flood protection.

The use in conjunction with so-called white goods and for protection against leaking automobile batteries is also possible. Basically, flat seals can thus be produced from this textile layer that are constructed of swelling fibers.

It is known to use geotextile seal liners, for example, made of the material “bentonite”, in order to achieve a seal of, for example, a certain ground area. Such a seal with mats or matting can, for example, be used in the area of construction sites or workshops, in order to prevent water or other undesirable substances from penetrating into the ground. The water or undesirable substances are retained by the seal liner, particularly the matting. These well-known bentonite mats do not ensure an absolute seal; they do, however, enable the best possible seal. A disadvantage of the well-known bentonite liners or mats, on the one hand, is the high surface weight of these mats, which makes their transport and installation difficult or costly. Another disadvantage of the bentonite mats is that, upon drying out, they can have drying cracks and exhibit increased permeability to liquids at these crack sites, in other words, following alternating dry-wet cycles, the bentonite mats largely lose their sealing properties. Moreover, concentrated loads on these bentonite mats, in particular, can result in the formation of cracks and subsequent leaks.

The proposal according to the invention, using a textile layer containing swelling fibers as the geotextile, fulfills the task that the swelling fibers absorb liquid and swell, and the thus resulting swell pressure enables a seal in the area of the sealing membrane and this at least reduces, if not even effectively interrupts, moisture from moving through the sealing membrane.

### DETAILED DESCRIPTION OF THE INVENTION

A sealing membrane according to the invention, for sealing against liquids, is a moisture-absorbing, swelling textile layer that comprises swelling fibers, which swell upon absorbing moisture and thereby produce a swell pressure. The swelling textile layer may be provided as a backing on a moisture-impermeable layer of material.

In an advantageous construction, the sealing membrane according to the invention is made exclusively of swelling fibers, in order to substantially reduce the movement or travel of moisture through the sealing membrane and, if necessary, to even achieve a complete seal.

In another embodiment, the sealing membrane is constructed as a blend of different materials, so that the swelling fibers comprise merely a portion of the material of the sealing membrane, for example, in a range of almost 100% to 10%.

In an advantageous construction, in addition to the swelling fibers, other materials may be also used, such as synthetic fibers, for example, polypropylene or polyester fibers, in order to achieve cost-effective production of the sealing membrane which, in its dry state, is also very tight and therefore easy to transport and install, and which, in addition to this, enables a high degree of long-term sealing.

A particularly advantageous fabrication of the sealing membrane is then achieved when the membrane is made of a swelling fleece, which, due to the simple manufacturability, enables a high swell pressure, for example, greater than 100 kg N, and the thus resulting good sealing properties.

Insofar as a portion of fusion fibers are provided in the swelling fleece, thermal fusion of the fibers can achieve a very high swell pressure that exhibits good sealing properties, when the swelling fibers are moistened. For this, the sealing membrane containing the fusion fibers is heated, for example, so that the fusion fibers fuse at least partially. The sealing membrane is then pressed together, and the fusion fibers are cooled, so that a relatively compact and strong, though also relatively thin, sealing membrane is created, which generates high swell pressure when the swelling fibers absorb moisture. When such fusion fibers are heated for the first time to the glass transition temperature, which is 80° C. when dry and significantly lower when wet, the fiber is soft and sticky for the duration of the transition. A strong irreversible bond between fibers is created if such fusion fibers that have become sticky then touch other fibers or if, in this sticky state, they are pressed against other fibers, for example, by roll compaction. Even a renewed application of heat does not dissolve the bond. Remarkably, the bonding sites are almost point-shaped, which has a positive affect on the grip and flexibility of the fleece material.

In an advantageous embodiment, the sealing membrane has mechanical fasteners on at least a portion of its edges or in the edge areas, for example, hook closures, zippers, buttons, or similar fasteners, in order, for example to fasten a textile sealing membrane with an adjacently arranged geotextile sealing membrane.

The proposed sealing membrane is constructed as a type of matting or membrane that can be, for example, several meters long and several meters wide, with a thickness of only one centimeter or a few centimeters. This mat-like constructed sealing membrane can, for example, be rolled up into a roll, so that, in one embodiment, this sealing membrane can have a width of one meter and a length of ten meters. Naturally, the sealing membrane can have different width and length measurements, depending upon the type of locality that is to be sealed.

The basis weight of a sealing membrane can, for example, lie in the range of 100 g to 5000 g/m², depending upon the desired application and desired sealing property. This basis weight itself already provides an important advantage of the inventive sealing membrane as a geotextile, in contrast to the basically heavier bentonite matting, which has identical sealing properties. Furthermore, the sealing property can be adjusted by means of the basis weight. The easy adjustability of the sealing properties also via the basis weight provides a basic advantage over the well-known seal mats or liners, which do not permit this adjustability in this manner.

In addition to the swellable fibers and, for example, an admixture of polypropylene and other synthetic fibers, the sealing membrane can also include some so-called fusion fibers, in order to enable a thermal fusion of the fibers to each other. The advantage of including the fusion fibers is that a higher swell pressure is obtained when the swelling fibers are moistened, as a result of thermally fusing the fibers to each other, after the fibers have been exposed to heat. This in turn results in an increased sealing capacity.

In one embodiment, the sealing membrane is made of a material that comprises 40% swelling fibers, 50% polypropylene or other synthetic materials or fibers, and 10% fusion fibers. Naturally, the proportions of this blend can vary depending upon the intended application.

A basic advantage of the proposed sealing membrane is that, even with repeated wet/dry cycles, the sealing properties of the sealing membrane remain intact, for example, in contrast to the known bentonite mats, which can form cracks during drying cycles and exhibit subsequent leaks associated with such cracks when the mats are remoistened.

A further advantage of the proposed sealing membrane is that it has an optimal alkaline stability, which is particularly important when the sealing layer is used in close proximity to concrete.

Another basic advantage of the sealing membrane according to the invention is that the proposed sealing membrane, particularly matting made of swelling fleece or swelling fibers, is groundwater-neutral and meets the criteria for food applications. A further essential advantage of the proposed sealing membrane is that the membrane also enables sealing in salt water applications.

It is possible, for example, to arrange additional layers on the top or bottom of the sealing membrane and to affix them to the sealing membrane, for example, one or more root-penetration-resistant layers, in order to prevent root-penetration damage to a geotextile sealing membrane when the sealing membrane is installed in the ground. This root-penetration-resistant layer can, for example, be made of a net or of another textile layer, such as, for example, another layer of fleece and/or felt.

Combining the sealing membrane with another water-impermeable layer has the advantage of having a water-impermeable sealing membrane that remains effective even then, when the additional water-impermeable layer is damaged, because the swelling fibers in the damaged area swell as a result of the moisture, and this prevents water from penetrating the damaged area.

1-15. (canceled)

16. A sealing membrane for sealing liquids, the membrane comprising:
a textile layer that includes moisture-absorbing fibers that are swellable and which, when swollen, provide a swell pressure.

17. The sealing membrane of claim 16, further comprising a moisture-impermeable layer of material, wherein the textile layer is disposed on the moisture impermeable layer.

18. The sealing membrane of claim 16, wherein the textile layer consists of swellable moisture-absorbing fibers.

19. The sealing membrane of claim 16, wherein the textile layer is constructed as a fleece layer.

20. The sealing membrane of claim 16, wherein the textile layer is constructed as a felt layer.

21. The sealing membrane of claim 16, wherein a portion of the textile layer is constructed of fusion fibers.

22. The sealing membrane of claim 16 further comprising fasteners attached to at least a portion of edges of the membrane, for fastening adjacent sealing membranes to each other.

23. The sealing membrane of claim 16, the textile layer including two or more textile layers, wherein the two or more layers are arranged one layer on top of another layer.

24. The sealing membrane of claim 17, further comprising a protective layer, wherein the protective layer covers the textile layer.

25. The sealing membrane of claim 24, wherein the moisture-impenetrable layer of material is constructed as a geomembrane layer.

26. The sealing membrane of claim 24, wherein the protective layer is constructed as a geomembrane layer.

27. The sealing membrane of claim 16, wherein the textile layer is strongly needle-bonded.

28. The sealing membrane of claim 16, wherein the textile layer includes fibers from a group of polymeric fibers that includes polyester fibers, polypropylene fibers, polyolefin fibers.

29. The sealing membrane of claim 16, wherein the textile layer includes synthetic fibers.

30. The sealing membrane of claim 16, further comprising a root-penetration-resistant layer.
